(19) United States
(12) Patent Application Publication
(10) Pub. No.: US 2025/0214443 A1
(43) Pub. Date: Jul. 3, 2025

(54) AERIAL GUIDED PILLAR TRACK VEHICLE TRAVEL SYSTEM

(71) Applicant: Dong REN, Kunming (CN)

(72) Inventor: Dong REN, Kunming (CN)

(21) Appl. No.: 19/087,433

(22) Filed: Mar. 21, 2025

Related U.S. Application Data
(63) Continuation of application No. PCT/CN2023/114644, filed on Aug. 24, 2023.

(30) Foreign Application Priority Data
Sep. 27, 2022 (CN) 202211181110.3

(51) Int. Cl. B60L 5/06; B60L 9/00

(52) U.S. Cl. CPC B60L 5/06; B60L 9/00

(57) ABSTRACT

An aerial guided pillar track vehicle travel system, including a pillar track electric vehicle and an aerial guided power supply system; wherein the pillar track electric vehicle comprises a coupling seat, a guiding pillar, a pillar track adaptive navigation system, elastic accessories, a first guiding strip and a second guiding strip, a rotating rod, a transmission component, a steering and transmission device of the pillar track electric vehicle, and a power assisting device. It solves the problem of driver driving and electronic guidance of autonomous vehicle in life, which can not avoid the safety risk of driving guidance caused by delayed response, and solves the carbon neutrality problem of public transportation; Suitable for automatic driving and manual assisted driving inside the air guided pillar track; Belonging to a new type of pillar track electric vehicle rail transit, energy-saving and environmental protection system.

### CROSS REFERENCE TO RELATED APPLICATIONS

This application is a continuation application of international application number PCT/CN2023/114644, filed Aug. 24, 2023, which claims priority to Chinese patent application 202211181110.3, filed on Sep. 27, 2022. The contents of these applications are incorporated herein by reference in their entirety.

### TECHNICAL FIELD

The present disclosure relates to the technical field of rail transit technology, in particular to an aerial guided pillar track vehicle travel system.

### BACKGROUND

Currently, petroleum vehicles cause serious environmental pollution. The latest and best new energy vehicles still rely heavily on batteries, hydrogen energy, etc. The high manufacturing costs result in significant energy consumption, and resources are depleting rapidly, leading to carbon emissions, further contributing to environmental pollution and damage. Manual driving and autonomous electronic guidance both have delayed responses in the order of seconds, causing safety risks in travel guidance. Directional control and drivers changing lanes illegally are the main direct cause of traffic incidents. These issues continuously pose threats to human life and property safety.

### SUMMARY

The purpose of the present disclosure is to address the shortcomings in the prior arts and provide an aerial guided pillar track vehicle travel system. The aerial guided pillar track vehicle travel system is resistant to flooding and electric shock, and offers advantages such as low accident rates, low operational costs, and energy efficiency, while being environmentally friendly. The aerial guided pillar track vehicle travel system integrates the novel pillar track electric vehicle with aerial guided pillar and power supply into a unified structure suspended in the air. It utilizes a single track for dual purposes, saving costs, and features an improved steering mechanism that is more convenient. The aerial guided pillar track vehicle travel system is suitable for all sizes of new pillar track electric vehicles, marking the transition of vehicles into a new era of aerial guided pillar track transportation. It is applicable to all new pillar track electric vehicles' aerial guided pillar track driving systems.

The guiding pillar's rotating seat is installed on the front part of a body of the pillar track electric vehicle. A rotating rod and belt pulley transmission system connect the steering and transmission device of the pillar track electric vehicle to the rotating seat, allowing it to rotate in connection with the guiding pillar. The rotating rod is connected to a speed-changing assembly and adjusts according to the steering angle and direction ratio of the modern guiding pillar and front wheels. One end of the rotating rod contacts the steering and transmission device of the pillar track electric vehicle, while the other end touches the extending the transmission component on the rotating seat. After matching the rotational speed change, the guiding pillar and the front wheels will have consistent steering angles and directions.

This new design alters the gear ratio in the steering and transmission device of modern pillar track electric vehicles, transforming the vehicle's steering system to operate similarly to a bicycle's handlebars. The vehicle's steering system remains unchanged by the gearbox, as this device can be directly installed. The guiding strips on the vehicle's guiding pillar and the other guiding strip allow safe, continuous gliding on both sides of the aerial guided pillar track, providing a continuous power supply for the vehicle. The vehicle automatically follows the guiding system inside the pillar track, making it suitable for automatic driving and manually assisted driving. The manufacturing and travel costs of the new pillar track electric vehicle are greatly reduced. the aerial guided pillar track vehicle travel system is suitable for all sizes of new pillar track electric vehicles.

The present disclosure primarily describes the aerial guided power supply system for monorail roads, with dual-track systems following similar principles to the disclosure.

This disclosure is realized through the following technical solutions.

An aerial guided pillar track vehicle travel system, comprising a pillar track electric vehicle and an aerial guided power supply system; the pillar track electric vehicle includes a coupling seat, a guiding pillar, a pillar track adaptive navigation system, elastic accessories, a first guiding strip and a second guiding strip, a rotating rod, a transmission component, a steering and transmission device of the pillar track electric vehicle, and a power assisting device; and the coupling seat is installed on the pillar track electric vehicle, with the first guiding strip and the second guiding strip connected by a circuit to a charging system of the pillar track electric vehicle; and a lower end of the guiding pillar is installed on the coupling seat, with the guiding pillar connected to the rotating rod, transmission component, and vehicle steering system; and an upper end of the guiding pillar is symmetrically installed with the first guiding strip and the second guiding strip; and the elastic accessories are between the first guiding strip and the second guiding strip; the first guiding strip and the second guiding strip are contacted to an aerial guided pillar track and slide on both sides of the aerial guided pillar track; the aerial guided power supply system comprises an aerial guided pillar track support pillar, an aerial guided pillar track connecting strip, a first aerial guided pillar track, a second aerial guided pillar track, a third aerial guided pillar tracks, a steering device, and a blocking rod; the aerial guided pillar track support pillar is installed on a road; and the aerial guided pillar track connecting strip is installed on an upper part of the aerial guided pillar track support pillar; and the aerial guided pillar track is installed on the aerial guided pillar track connecting strip; the aerial guided power supply system further comprises a multiple of entrances, turns, and lane changes based on the road conditions, with protruding connectors; a steering device is installed according to road conditions; and insulation materials are provided above and below a positively charged first aerial guided pillar track, and the first aerial guided pillar track and second aerial guided pillar track are connected to a power supply system via circuits.

The pillar track electric vehicle is a rechargeable vehicle, including an electric car, an electric bicycle, an electric motorcycle, and an electric tricycle; a vehicle steering system is modified through the transmission component to synchronize a front wheel steering angle of the vehicle with that of the guiding pillar; the pillar track electric vehicle is equipped with the pillar track adaptive navigation system; and the pillar track adaptive navigation system is configured to send signal-powered turn signals to the steering device and activate functions of start, stop, turn right and turn left; and the guiding pillar is installed on the pillar track electric vehicle through the coupling sea. The whole pillar track electric vehicle also includes an improved battery management technology, a charging control technology, a motor and its control technology, a steering control technology, signal light control technology, a whole vehicle control technology, and a whole vehicle lightweighting technology for modern new pure new pillar track electric vehicle.

Furthermore, the first guiding strip and the second guiding strip are two pieces of materials with high strength, low elasticity, and waterproof properties, such as stainless steel or aluminum alloy, which also have guiding and conductive functions. The first guiding strip and the second guiding strip are cylindrical or square in shape and come into contact with the aerial guided pillar track. They are divided into two types: one with a rotating rod and one without. The thickness of the first guiding strip and the second guiding strip ranges from 30 cm to 180 cm, and a height is 18 cm to 48 cm higher than the aerial guided pillar track. The first guiding strip and the second guiding strip are elastically mounted with insulating accessories on the upper section of the guiding pillar. Alternatively, one guiding strip and the width of the guiding pillar, as well as the height of the upper end of the guiding pillar, can be matched with the first guiding strip and the second guiding strip mounted with insulating accessories on the guiding pillar, with the upper part of the guiding pillar replacing the second guiding strip.

Furthermore, the guiding pillar is adjustable in height. The guiding pillar is raised when the pillar track electric vehicle needs to enter the aerial guided pillar track for charging or automatic driving, and lowered when it is not needed to disengage from the aerial guided pillar track. It is installed on a rotating seat, which is mounted on the front part of the body of the pillar track electric vehicle. A rotating rod connects the steering device of the pillar track electric vehicle to the rotating seat, allowing rotation with the guiding pillar. The rotating rod is connected to a steering and transmission device, which adjusts based on the ratio of the guiding pillar and front wheel steering angles and directions. One end of the rotating rod contacts the speed-changing component of the steering and transmission device of the pillar track electric vehicle, while the other end contacts the rotating seat of the guiding pillar. The rotating seat has a corresponding speed-changing component. After matching the speed change, the guiding pillar and the front wheel steering angles and directions become consistent. When manufacturing a new vehicle or modifying the gear ratio of aerial guided pillar track vehicle travel system, the vehicle's steering system can be transformed to work like a bicycle's handlebars, without the need for gearbox changes. By using the above method, the steering system can be directly installed to achieve this transformation.

Furthermore, the pillar track adaptive navigation system includes a system for the new pillar track electric vehicle that allows for lane changes to the left and right, turning left or right at intersections without traffic lights, and recognizing traffic lights at crossroads. The pillar track adaptive navigation system detects the pillar track electric vehicle's position and direction. When the pillar track electric vehicle is approaching an intersection or a direction where the car's distance is too short, a signal is only emitted when effective. The distance between the vehicles is set according to general road and highway regulations. On shared lanes, the signal emitted from the vehicle to the new steering mechanism is short, and the vehicle's signal activates the splitter at the corresponding section of the aerial guided pillar track. The insulating connection at one end of the steering pillar track diverges from one aerial guided pillar track to another. The vehicle then moves from the original aerial guided pillar track and lane to the new aerial guided pillar track and lane, while the following vehicle maintains the same direction as the leading vehicle. After passing through, the insulating connection steers the vehicle back to the original aerial guided pillar track. The new pillar track electric vehicle's pillar track adaptive navigation system adjusts the speed according to the navigation segments of the road, accurately controlling the speed of the vehicle. Under the guidance of the aerial guided pillar track, the vehicle accelerates, decelerates, steers, and stops automatically for a safe and autonomous drive.

Furthermore, the aerial guided pillar track is composed of first aerial guided pillar track and second aerial guided pillar track, divided into single-rail aerial guided pillar track and dual-rail aerial guided pillar track. Two aerial guided pillar tracks are insulated and installed together to form a single-rail aerial guided pillar track. The two guiding strips are arranged in the middle for the aerial guided pillar track to slide, and are installed on the upper part of the guiding pillar through elastic accessories. The guiding strips slide on the outer sides of both sides of the single-rail aerial guided pillar track. Two aerial guided pillar tracks are installed with insulation in the middle to form the dual-rail aerial guided pillar track. The first guiding strip and the second guiding strip, which are elastically insulated, are installed on the upper section of the guiding pillar, and the first guiding strip and the second guiding strip slide within the dual-rail aerial guided pillar track. The aerial guided pillar track has several grooves according to the road route, and each entrance is equipped with an entrance blocking rod and a steering device. The vehicle slides into the aerial guided pillar track along the entrance blocking rod.

Furthermore, the road and track curvature for the vehicle's forward motion range from large curves with a radius of about 8 to 173 degrees, allowing the vehicle to slide along the pillar track. For small or sharp curves, with a radius less than 173 degrees and greater than 8 degrees, the vehicle's direction is controlled either by the driver or adaptive navigation system, which detects the torque on the guiding pillar. When this torque reaches a certain level, it automatically activates the electric steering assist to rotate the direction for forward motion. The coupling seat of the guiding pillar is installed on the front part of the vehicle. The steering and transmission device for the pillar track electric vehicle is equipped with an electric pillar track automatic transmission. It controls the steering assist based on the torque and direction signals from the guiding pillar. The guiding pillar and the vehicle's front wheel steering angles and directions become consistent.

Furthermore, the coupling seat of the guiding pillar is extended and installed on the steering wheel seat. The front wheels are mounted on the steering seat. In the case of one steering wheel, it is installed in the middle of the bottom of the front part. In the case of two steering wheels, they replace the original front wheels or are installed in nearby positions. The steering wheels are available in two configurations: with or without a lifting function. When the guiding pillar is about to enter the track, the steering seat is lowered, and the front wheels contact the ground. The guiding pillar device raises the guiding pillar, guiding the vehicle to follow the pillar track. The guiding pillar and the vehicle's front wheel steering angles and directions remain consistent.

Furthermore, the steering device includes a elastic accessory and a coupling steering pillar track. It adds an electric device controlled by traffic lights at intersections, along with a signal device for wireless control of lane changes and turns. The surface can be insulated and features automatic closing, bridging, and opening of the openings. The electric device and signal device are set at entry points of the pillar track electric vehicle. The added electric device is controlled by the traffic lights at crossroads, while the signal device is controlled by the adaptive navigation system of the pillar track electric vehicle to control lane changes and turns. The surface can be insulated and features automatic closing, bridging, and opening functions. One end is installed at the rear of the aerial guided pillar track's opening using the elastic accessories of the steering device. The other end automatically closes the opening when there is no vehicle at the entrance. The turning points of the track use the steering device with a signal-powered mechanism. The pillar track's adaptive navigation system sends information to the steering device, instructing it to activate in the specified direction for left or right turns or lane changes. Left and right signals have different frequencies. At intersections with traffic lights, a signal-free steering device is used, controlled by the traffic lights.

Furthermore, the pillar track is equipped with a steering limit function. At the entrance, the steering angle of the pillar track when the vehicle enters from the right is between 50 and 90 degrees. When entering from the left, the angle is between 90 and 130 degrees. After each movement, the aerial guided pillar track vehicle travel system automatically resets to the original pillar track position. The lane change and turning steering angles reset back to the original pillar track position. The steering angle adjusts to the new pillar track position, and at intersections, it resets to the original position. When the red light is on, the aerial guided pillar track vehicle travel system rises to approximately a right angle.

Furthermore, the power assisting device is controlled by the pillar track adaptive navigation system, adjusting the torque converter and transmission according to the torque direction of the guiding pillar. It provides an appropriate signal to synchronize the steering direction of the guiding pillar and the vehicle's front wheels.

Furthermore, the guiding pillar is equipped with a braking device. The driver can activate the braking system from the driving cab, especially when descending a steep slope and when the brakes fail. The braking device on the guiding pillar increases friction with the aerial guided pillar track to slow down the vehicle.

The advantages of the present disclosure are as follows:
1. The aerial guided pillar track vehicle of the present disclosure solve the issue of several seconds of delay in the electronic steering zero point response in both manual and autonomous driving, which leads to potential safety risks in driving guidance. The pillar track electric vehicle reduces the need for a large number of batteries, scientifically uses electricity directly, and reduces the significant costs, carbon emissions, pollution, and resource depletion associated with battery and hydrogen production. It has a very low accident rate, low operating costs, and significant environmental advantages.
2. The driving system of the present disclosure controls the guiding pillar within the aerial guided pillar track, and the guiding pillar is 18 to 48 decimeters higher than the track, so it will not detach from the aerial guided pillar track, providing safe, energy-efficient, and environmentally friendly travel for humans.
3. Vehicles running on the aerial guided pillar track highway or other road connection rods with aerial guided pillar tracks can be driven without a driver from a distance, as the vehicle is controlled by the adaptive navigation system, enabling safe autonomous driving.
4. The driving impact during fog, icy roads, and rainy or snowy weather is reduced compared to current driving conditions.
5. City buses and other large vehicles can be modified to have a lower rear body, making them more convenient.
6. The disclosure ensures the highest level of driving safety with a human-centered design. It reduces the performance and safety gap between high-end and low-end vehicles in terms of speed and safety.
7. It eliminates the risk of driver fatigue and illegal driving behavior such as arbitrary lane changes and traffic violations that lead to accidents.
8. The pillar track electric vehicle uses brake energy regeneration technology, converting the friction between the brakes, guiding pillars, and the aerial guided pillar track into electrical energy, which is then returned to the vehicle's charging or power supply system.
8. Compared to trams, trains, high-speed trains, and subways, the present disclosure is applicable to all types of vehicles. Electric companies can charge based on the vehicle's electric meter or toll fees.
9. On roads with fewer vehicles, where there is only one aerial guided pillar track for bidirectional lanes, a set of guiding pillar devices can be installed on both sides of the vehicle's front.

### BRIEF DESCRIPTION OF THE DRAWINGS

FIG. 1 is a side view of an aerial guided pillar track vehicle travel system according to an embodiment of the present disclosure.

FIG. 2 is a front view of the aerial guided pillar track vehicle travel system according to an embodiment of the present disclosure.

FIG. 3 is a top view of the aerial guided pillar track vehicle travel system according to an embodiment of the present disclosure.

FIG. 4 is a schematic structural diagram of a single track aerial guided pillar track of the aerial guided pillar track vehicle travel system in FIG. 1.

FIG. 5 is a schematic structural diagram of a dual track aerial guided pillar track of the aerial guided pillar track vehicle travel system in FIG. 1.

FIG. 6 is a schematic structural diagram of a guiding pillar of the aerial guided pillar track vehicle travel system in FIG. 1.

FIG. 7 is a schematic diagram of the partial structure between the guiding pillar and the transmission component of the present disclosure.

FIG. 8 is a schematic diagram of the installation of the power assisting device of the present disclosure.

FIG. 9 is a schematic diagram of the guiding pillar of the present disclosure having an N-shaped structure.

### DESCRIPTION OF THE REFERENCE NUMERAL

1 coupling seat, 2 guiding pillar, 3 first guiding strip, 4 second guiding strip, 5 pillar track adaptive navigation system, 6 pillar track electric vehicle, 7 aerial guided pillar track support pillar, 8 aerial guided pillar track connecting strip, 9 first aerial guided pillar track, 10 second aerial guided pillar track, 11 aerial guided pillar track, 12 steering device, 13 elastic accessory, 14 blocking rod, 15 rotating rod, 16 transmission component, 17 steering and transmission device, 18 power assisting device.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

Those skilled in the art will understand that the following examples are intended to illustrate the present disclosure and should not be construed as limiting the scope of the disclosure. In the examples, where specific technologies or conditions are not mentioned, they should be performed according to the techniques or conditions described in the literature of the field or as per the product manuals. For materials or equipment not specified with a manufacturer, they are conventional products that can be obtained through purchase.

### Embodiment 1

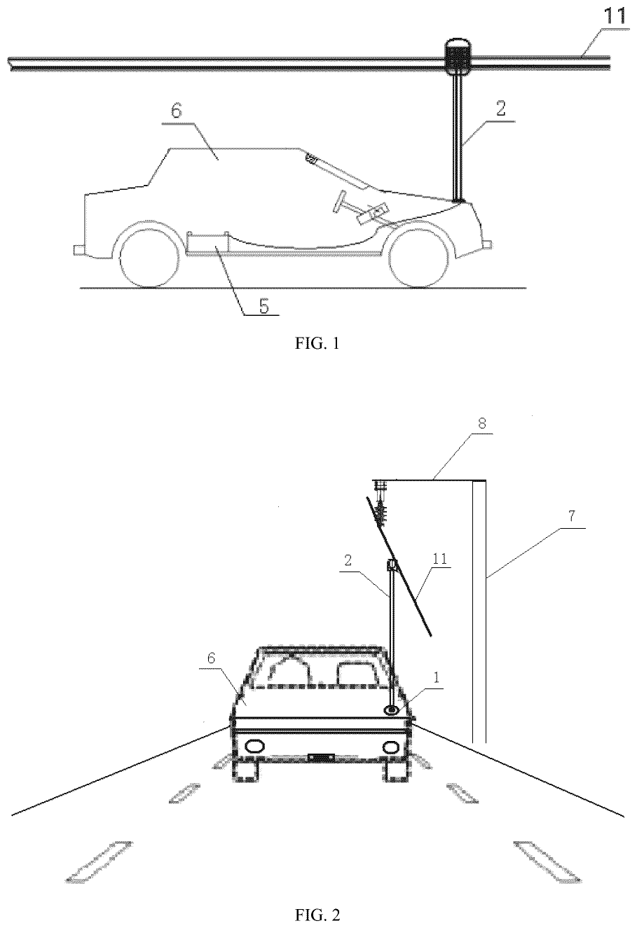

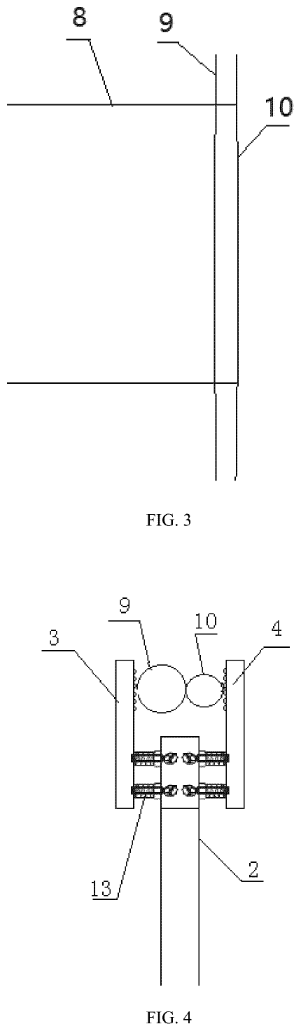

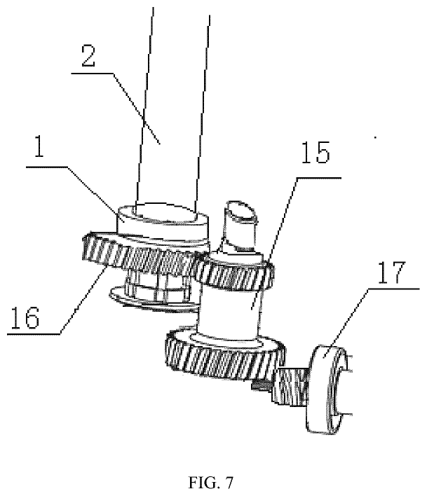

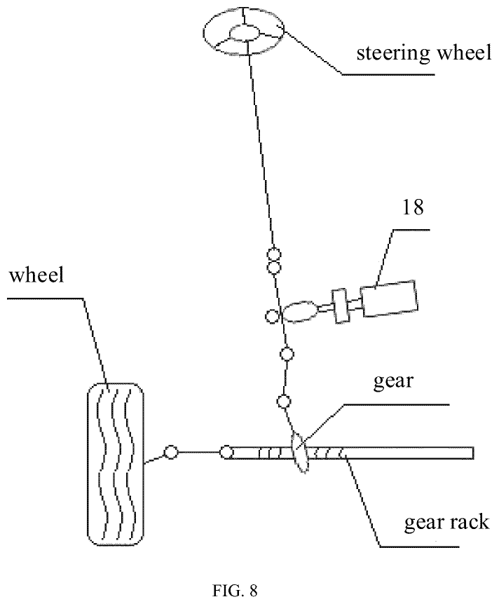

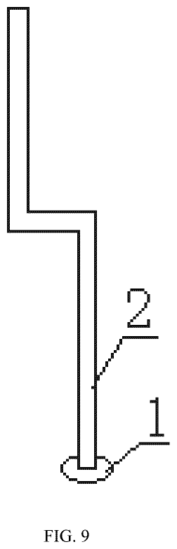

As shown in FIGS. 1-9, the steering and transmission device 17 of the pillar track electric vehicle 6 of the present disclosure is installed with a transmission component 16, and one end of the rotating rod 15 is connected to the transmission component. The other end of the rotating rod 15 is connected to the transmission component 16 and installed on the guiding pillar 2 at the front part of a body of the pillar track electric vehicle. The coupling seat 1 is connected and installed to transmit power. By changing the number of teeth on the rack and pinion in the steering and transmission device 17 of pillar track electric vehicle 6, the turning ratio is changed so that when the front wheels steer, the angle and direction of the front wheels match the angle and direction of the guiding pillar 2.

The coupling seat 1 is installed at the front of the body of the pillar track electric vehicle, and the second guiding strip 4 are connected via wiring to a charging system of the pillar track electric vehicle 6. A lower end of the guiding pillar 2 is installed on the coupling seat 1, and the second guiding strip 4 at the top of the guiding pillar 2 comes into contact with the aerial guided pillar track 11.

On the road, the aerial guided pillar track support pillars 7 are installed, and each of the aerial guided pillar track support pillar 7 is equipped with a track connecting strip 8. The aerial guided pillar track 11 is installed on the aerial guided pillar track connecting strip 8, and the aerial guided pillar track 11 can be set up as one or more tracks depending on the road conditions, either as a two-way or one-way track. The aerial guided pillar track 11 serves as a guiding and power supply function, and the power system can use any of the existing power technologies from electric trams, high-speed rail, subways, or urban electric buses. The first aerial guided pillar track 9 and second aerial guided pillar track 10 are connected via wiring to the power system. The positive voltage aerial guided pillar tracks 11 and others are all insulated, and insulating materials may be installed above and below the positive voltage aerial guided pillar tracks 11. The other aerial guided pillar track, which carries negative voltage, does not require insulation. The power system delivers electricity to the aerial guided pillar tracks 11, which transmits through contact with the first guiding strip 3, the second guiding strip 4 and wiring to the charging system of the pillar track electric vehicle 6. The wiring loop returns to the guiding strips (the guiding strips include the first guiding strip 3 and the second guiding strip 4), and the wiring loop of the aerial guided pillar track 11 returns to the power system, forming a complete power supply system. During the operation of pillar track electric vehicle 6, the vehicle will automatically charge, and once this technology is widely adopted, it will eliminate the need for investment in charging stations or gas stations, thus saving land resources.

As shown in FIG. 4, the aerial guided pillar track 11 is a single track, and the first aerial guided pillar track 9 and the second aerial guided pillar track 10 are installed close together and insulated, forming the aerial guided pillar track 11. The second guiding strip 4 are equipped with elastic accessories 13 and are installed separately on the guiding pillar 2. The second guiding strip 4, using the tensile force of the elastic accessories 13, slide along both sides of the aerial guided pillar track 11.

The second guiding strip 4 is in contact with the first aerial guided pillar track 9 and the second aerial guided pillar track 10, with the inner sides of the second guiding strip 4 either having rotating rods or not having rotating rods. The second guiding strip 4 slide along both sides of the aerial guided pillar track 11, with the front ends of the second guiding strip 4 made of elastic material and higher than the aerial guided pillar track 11 to reduce equipment friction and wear, and to adapt to more complex road conditions, such as mountain roads. The pillar track electric vehicle 6 is equipped with a pillar track adaptive navigation system 5, which sends out commands for the pillar track electric vehicle 6 to turn left or right, activating the signal-powered steering device 12. By simply inputting the destination, and using the global positioning system (GPS) satellite positioning system, the pillar track adaptive navigation system 5 provides road condition information, accurately controlling acceleration of the pillar track electric vehicle 6, deceleration, steering, and parking actions under the guidance of the aerial guided pillar track 11.

The aerial guided pillar track vehicle travel system also includes modern technologies such as adaptive navigation system of the pillar track electric vehicle, battery management system (BMS), high-voltage distribution box safety technology, high-voltage connectors, and high-voltage wiring safety measures, forming a new type of pillar track electric vehicle. This pillar track electric vehicle automatically guides and charges within the hardware facilities of the aerial guided pillar track.

The safe and energy-efficient driving system of the aerial guided pillar track 11 significantly reduces traffic accidents, using existing electric tram, high-speed rail, subway, or electric bus power supply technologies as the power system. The vehicle charges while driving safely, and the fee is based on household meters or toll charges. Except for heavy-duty vehicles, the guiding pillar device is installed at the center of gravity of the pillar track electric vehicle, and after the guiding pillar slides into the aerial guided pillar track, it rises a segment. The top of the guiding pillar, equipped with a driving wheel device, turns along one side of the pillar track. The guiding pillar then rises further, and the pillar track electric vehicle 6 becomes airborne. The first guiding strip 3 and the second guiding strip 4 respectively contact the first aerial guided pillar track 9 and the second aerial guided pillar track 10, allowing the pillar track electric vehicle 6 to slide along it. The top of the guiding pillar 2, equipped with a driving wheel, rotates and contacts the aerial guided pillar track 11 for forward movement, achieving the purpose of not needing to build or maintain roads. The pillar track electric vehicle is started by inputting the destination, enabling the delivery at place A and the receipt at place B without manual driving.

### Embodiment 2

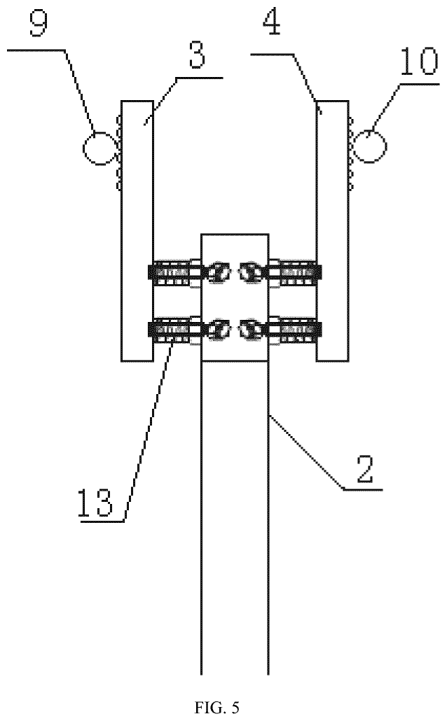

The embodiment shows the signal track of aerial guided pillar track 11, the embodiment 2 aims to disclose dual track of aerial guided pillar track 11. The pillar track electric vehicle 6, and the pillar track adaptive navigation system 5 are set up in the same way as in Embodiment 1. As shown in FIG. 5, the aerial guided pillar track 11 is a dual track. The aerial guided pillar track 9 and another aerial guided pillar track 10 are installed with an insulated separation space for the guiding pillar 2 to slide in between, forming the dual track of the aerial guided pillar track. The first guiding strip 3 and the second guiding strip 4 have elastic accessories 13 between them, which are insulated and mounted on the guiding pillar 2. The first guiding strip 3 and the second guiding strip 4 slide along the dual track of the aerial guided pillar track 11 with the tension of the elastic accessories 13.

Another solution involves the second guiding strip 4 being insulated and installed on the upper section of the guiding pillar 2 through the elastic accessories 13. The upper section of the guiding pillar 2 can also replace the second guiding strip 4. When the second guiding strip 4 comes into contact with the first aerial guided pillar track 9 for power collection, the second guiding strip 4 and the second aerial guided pillar track 10 form a contact circuit. The second guiding strip 4 is insulated and mounted on the guiding pillar 2 to prevent short circuits. The aerial positive-electrical-guided pillar track is connected to the power supply system through the power line, and everything else is insulated. The aerial positive-electrical-guided pillar track is equipped with insulation materials both above and below. The other aerial guided pillar track and the aerial positive-electrical-guided pillar track have insulated contact points, while the rest do not require insulation. The first aerial guided pillar track 9 is connected to the power supply system via the power supply line, transmitting power to the first aerial guided pillar track 9. Through contact with the guiding strip and through the power line, the vehicle charging system is powered, and the power is returned through the circuit to the guiding strip, while the other aerial guided pillar track 10 is connected back to the power supply system.

The upper section of the guiding pillar 2 is 18 to 40 decimeters longer than the aerial guided pillar track 11, which helps to prevent the guiding pillar 2 from sliding out of the track in case of uneven road surfaces. The guiding pillar 2, coupling seat 1, the first guiding strip 3 and the second guiding strip 4 are made of wear-resistant materials, such as graphene, to ensure electrical conductivity and proper guidance when in contact with the aerial guided pillar track 11. In case of a vehicle failure, mechanical power can be used to manually and easily dismantle, bend, or lift the guiding pillar 2, allowing it to exit the aerial guided pillar track 11, which enables the faulty vehicle to drive out autonomously.

### Embodiment 3

The single track of the aerial guided pillar track 11 is as described in Embodiment 1, and the dual track aerial guided pillar track 11 is as described in Embodiment 2. The new pillar track electric vehicle 6, the road aerial guided power supply device system, and the pillar track adaptive navigation system 5 are set up in the same way as in Embodiment 1. In this embodiment, based on the road entrances and exits, and the need for lane merging, multiple corresponding openings are set at appropriate positions on the aerial guided pillar track 11. Each opening is equipped with a corresponding new type of steering device 12, which uses a shape, such as a curved or arched form, where the aerial guided pillar track connecting bar is used for connection, rotation, and electrical contact.

The guiding pillar 2 enters the opening of the aerial guided pillar track 11 through the new type of steering device 12, where a blocking rod 14 is positioned at the front to prevent the guiding pillar 2 from sliding into the aerial guided pillar track 11. Left and right turns or lane merging are controlled by the pillar track adaptive navigation system 5, either through manual control or navigation system instructions. Left or right turn signals are used, and the system sends instructions to activate the new type of steering device 12, guiding the pillar track electric vehicle 11 travels along the aerial guided pillar track 11. The steering device 12 directs the pillar track electric vehicle 6 based on the left or right turn signal, with different frequencies for each turn signal, controlling activation of the new type of steering device 12.

The aerial guided pillar track 11 is designed in two height categories: one is between 1.8 meters and 2.8 meters, for vehicles with a body lower than the height of the track. The guiding pillar 2 is installed on the front part of the vehicle' s body. For larger vehicles traveling below the pillar track, the rotating seat 1 extends, and the guiding pillar 2 is mounted on the side of the larger vehicle, which travels along the side of the aerial guided pillar track 11. This allows both large and small vehicles to share the same track, saving construction and maintenance costs. A dedicated new type of steering device 12 for large vehicles is used for turning, with the track section functioning similarly to an electric vehicle release coupling rod that raises and lowers. The second type involves setting a dedicated lane for large vehicles, with the aerial guided pillar track 11 height ranging from 2.9 meters to 4 meters.

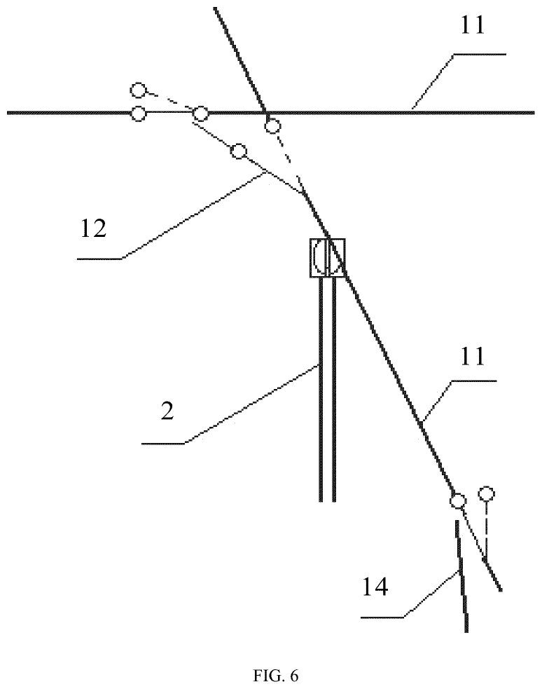

As shown in FIG. 6, the new type of steering device 12 consists of a steering device with elastic accessories 13 that connect to the steering pillar track. It is used for the track entry point, incorporating an electric device controlled by traffic lights at an intersection. A signal device is added, enabling wireless control of lane changes and turns from the vehicle. The surface may be insulated, and the device automatically closes, bridges, and opens the track entry points. One end is mounted through the elastic accessory at the rear of the opening on the aerial guided pillar track 11, while the other end, under the force of the elastic accessories 13, automatically closes the opening after the pillar track electric vehicle 6 passes through, ensuring that normal vehicles pass smoothly.

For single track entry, the new type of steering device 12 is installed at the rear of the entrance to the aerial guided pillar track 11, with a slanted blocking rod 14 installed nearby. As the guiding pillar 2 moves forward at the track entrance, it is directed by the blocking rod 14, and the guiding pillar 2 is pushed into the track by the forward thrust of the pillar track electric vehicle 6. The guiding pillar 2 then slides into the aerial guided pillar track 11. The first guiding strip 3 on the guiding pillar 2 and the aerial guided pillar track 9 come into contact to collect power, while the second guiding strip 4 forms a contact circuit with the second aerial guided pillar track 10.

At traffic light-controlled cross roads, in the first scenario, when the green light is on for straight traffic, the intersection controller automatically connects all electric new type steering devices in the straight direction, or T-type steering devices, which connect to and direct the pillar track electric vehicle 6 along the straight path. When the red light is on, the steering devices retract and form a right angle. During the left turn green light period, all new type steering device 12 in the left turn direction are activated. Vehicles first travel straight through the intersection, and according to the signal lights, they are directed to the left lane. During the U-turn green light period, all new type steering devices for the U-turn direction are activated, allowing vehicles to follow the U-turn track.

When the new type pillar track electric vehicle 6 merges left or right at an intersection without traffic lights, the pillar track adaptive navigation system 5 detects when the pillar track electric vehicle 6 is close to the direction of turn and sends a signal. For shared lane entries, the signal of the pillar track electric vehicle 6 is transmitted to the new type steering device, which then activates the signal on the nearest corresponding section of the aerial guided pillar track 11. The insulated steering pillar track is connected from one track to another as the vehicle moves, switching lanes smoothly. The vehicle moves from one track to another, with subsequent vehicles following the same path. Once no vehicles are ahead, the pillar track adaptive navigation system 5 adjusts the speed based on the road segments, ensuring safe, automatic driving.

### Embodiment 4

In this embodiment the aerial guided pillar track vehicle travel system is set on mountain roads. The pillar track electric vehicle 6, aerial guided power supply and the pillar track adaptive navigation system 5 are the same as that of embodiment 1. The pillar track electric vehicle 6 in mountainous areas choose to install corner blocks at the top of the guiding strips. The corner block only turns the pillar track electric vehicle 6 towards one side of the aerial guided pillar track 11, enhancing safety. A blocking rod 14 is set at the entrance of the aerial guided pillar track 11 to prevent the guiding pillar 2 from sliding into the track. All vehicles follow the direction of the aerial guided pillar track 11, ensuring there are no dangerous situations such as entering a ravine due to poor road conditions or colliding with oncoming vehicles due to poor visibility.

During manual assisted driving, when passengers need to charge, the guiding pillar 2 is raised to drive into the aerial guided pillar track 11. When charging is not needed, the guiding pillar 2 is lowered.

### Embodiment 5

The aerial guided pillar track vehicle travel system is installed on traffic roads, with the new pillar track electric vehicle 6, aerial guided power supply system, and the pillar track adaptive navigation system 5, all configured the same as in Example 1. In complex road conditions, with larger road curves and vehicle turning, the positions of the aerial guided pillar track pillar 7 and the aerial guided pillar track connecting strip 8 can be adjusted. Based on the actual road curvature, multiple aerial guided pillar track connecting strips 8 can be connected in series, or the length of the connecting strips 8 can be extended to ensure that the aerial guided pillar track 11 is positioned appropriately on the road. This prevents the pillar track electric vehicle 6 from colliding with the aerial guided pillar track pillar 7.

The above shows and describes the basic principles, main features, and advantages of the invention. Those skilled in the art should understand that the invention is not limited to the above embodiments. The embodiments and descriptions above are merely intended to explain the principles of the invention. Without departing from the spirit and scope of the invention, various changes and modifications can be made, all of which fall within the protection scope of the invention. The scope of protection for the invention is defined by the appended claims and their equivalents.

1. An aerial guided pillar track vehicle travel system, comprising a pillar track electric vehicle (6) and an aerial guided power supply system;
wherein the pillar track electric vehicle (6) comprises a coupling seat (1), a guiding pillar (2), a pillar track adaptive navigation system (5), elastic accessories (13), a first guiding strip (3) and a second guiding strip (4), a rotating rod (15), a transmission component (16), a steering and transmission device (17) of the pillar track electric vehicle (6), and a power assisting device (18); and
the coupling seat (1) is installed on the pillar track electric vehicle (6), with the first guiding strip (3) and the second guiding strip (4) connected by a circuit to a charging system of the pillar track electric vehicle (6); and
a lower end of the guiding pillar (2) is installed on the coupling seat (1), with the guiding pillar (2) connected to the rotating rod (15), transmission component (16), and vehicle steering system; and
an upper end of the guiding pillar (2) is symmetrically installed with the first guiding strip (3) and the second guiding strip (4); and
the elastic accessories (13) are between the first guiding strip (3) and the second guiding strip (4); the first guiding strip (3) and the second guiding strip (4) are contacted to an aerial guided pillar track (11) and slide on both sides of the aerial guided pillar track (11);
wherein, the aerial guided power supply system comprises an aerial guided pillar track support pillar (7), an aerial guided pillar track connecting strip (8), a first aerial guided pillar track (9), a second aerial guided pillar track (10), a third aerial guided pillar tracks (11), a steering device (12), and a blocking rod (14);
wherein the aerial guided pillar track support pillar (7) is installed on a road; and
the aerial guided pillar track connecting strip (8) is installed on an upper part of the aerial guided pillar track support pillar (7); and
the aerial guided pillar track (11) is installed on the aerial guided pillar track connecting strip (8);
the aerial guided power supply system further comprises a multiple of grooves according to entrances, turns, and lane changes of the road conditions, with protruding connectors; a steering device (12) is installed according to road conditions; and
insulation materials are provided above and below a positively charged first aerial guided pillar track (9), and the first aerial guided pillar track (9) and second aerial guided pillar track (10) are connected to a power supply system via circuits.

2. The aerial guided pillar track vehicle travel system according to claim 1, wherein the pillar track electric vehicle (6) is a rechargeable vehicle, comprising an electric car, an electric bicycle, an electric motorcycle, and an electric tricycle;
a vehicle steering system is modified through the transmission component (16) to synchronize a front wheel steering angle of the vehicle with that of the guiding pillar (2);
the pillar track electric vehicle (6) is equipped with the pillar track adaptive navigation system (5); and
the pillar track adaptive navigation system (5) is configured to send signal-powered turn signals to the steering device (12) and activate functions of start, stop, turn right and turn left; and
the guiding pillar (2) is installed on the pillar track electric vehicle (6) through the coupling seat (1).

3. The aerial guided pillar track vehicle travel system according to claim 1, wherein the aerial guided pillar track (11) comprises the first aerial guided pillar track and the second aerial guided pillar track (10);
the first guiding strip (3) and the second guiding strip (4) respectively contact with the first aerial guided pillar track and the second aerial guided pillar track (10); and
the aerial guided pillar track (11) comprises grooves; and
positive and negative currents are transmitted through protruding connectors from the grooves of the aerial guided pillar track (11); and
positive and negative current of external parts of the aerial guided pillar track (11) are transmitted through the first aerial guided pillar track (9) and the second aerial guided pillar track (10); and
the blocking rod (14) and the steering device (12) are set on the groove; and
the pillar track electric vehicle (6) is set slide into the aerial guided pillar track (11) along the blocking rod (14); and
a signal-powered device is equipped on the steering device (12).

4. The aerial guided pillar track vehicle travel system according to claim 1, wherein the coupling seat (1) is installed on a front part of the pillar track electric vehicle (6);
the guiding pillar (2) is shaped as an inverted Z, N, or L shape;
a lower part of the guiding pillar (2) is installed on the coupling seat (1), extending 8 to 40 centimeters below a bearing of the coupling seat (1);
the extending the transmission component (16) is equipped below the guiding pillar below the coupling seat (1);
the extending the transmission component (16) comprises a gear installed on the steering system and large gears, small gears, belt pulleys, and a transmission racks installed on the rotating rod (15);
the large gears, the small gears, belt pulleys, and transmission racks of the transmission component (16) are set in pairs and are are linked to rotate, and after shifting, the steering angle of the front wheel and the transmission rack of the guiding pillar are synchronized;
when manufacturing new vehicle or modifying the steering transmission device (17) of the pillar track electric vehicle (6), the gear ratio of the rack and small gear rotates proportionally; the vehicle steering system does not require shifting, and the steering system is directly connected to the coupling seat (1) of the guiding pillar through the rotating rod, gears, belt pulleys, and racks, making the steering angle of the front wheel and the steering angle the guiding pillar steering angle consistent;

5. The aerial guided pillar track vehicle travel system according to claim 1, wherein the steering device (12) comprises a elastic accessory and a coupling steering pillar track; and the steering device (12) is located at a track entrance;
a electric device is controlled by traffic lights at intersections, left and right lane changes and turns are controlled by the pillar track adaptive navigation system (5), which sends signals to the steering device (12);
a surface of the steering device (12) may be insulated and equipped with a function of automatic closure, bridging, and opening gaps;
one end is installed at a rear end of a gap of the aerial guided pillar track (11) through the elastic accessory;
after the pillar track electric vehicle (6) changes lanes or turns through the gap, if no other vehicle exits or enters the gap, the other end, under the action of the elastic accessory (13), automatically returns to an original position and closes the gap.
